(19) United States
(12) Patent Application Publication
(10) Pub. No.: US 2026/0219090 A1
(43) Pub. Date: Jul. 30, 2026

(54) SYSTEMS, DEVICES, AND METHODS FOR VOLUMETRIC MEASUREMENT USING MULTIPLE NON-COPLANAR CAMERAS

(71) Applicant: BarnTools, LLC, Urbandale, IA (US)

(72) Inventors: Jim Ryken, Urbandale, IA (US); Alexander Lesnick, Ashburn, VA (US); Chen Feng, Waukee, IA (US)

(21) Appl. No.: 19/462,353

(22) Filed: Jan. 28, 2026

Related U.S. Application Data
(60) Provisional application No. 63/750,341, filed on Jan. 28, 2025.
(60) Provisional application No. 63/770,691, filed on Mar. 12, 2025.

(51) Int. Cl. G01F 23/292; G01F 25/20

(52) U.S. Cl. CPC G01F 23/292; G01F 25/20

(57) ABSTRACT

In the field of volumetric measurement, this technology addresses the challenge of accurately determining the fill level of containers, such as feed bins, by utilizing a sensor system with multiple direct Time of Flight (dTOF) sensors. These sensors are arranged in non-coplanar positions to expand the field of view through FOV Multiplexing, capturing comprehensive depth data from the bin's interior. The method involves processing this data by digitally stitching it to form a concatenated image, estimating the bin's volume, and outputting the result. The system self-calibrates by measuring essential bin dimensions, eliminating user input, and includes a cleaning mechanism for sensor maintenance. The technology is adaptable for various container types, including liquid and shipping containers, and can be powered by a solar-powered battery module. This approach offers a cost-effective and accurate solution for volumetric measurement in diverse applications.

### CROSS-REFERENCE TO RELATED APPLICATIONS

This application claims the benefit under 35 U.S.C. §119(e) to U.S. Provisional Application 63/750,341, filed Jan. 28, 2025 and entitled “Systems, Devices, and Methods for Volumetric Measurement Using Multiple Non-Coplanar Cameras,” and U.S. Provisional Application 63/770,691, filed Mar. 12, 2025 and entitled “Systems, Devices, and Methods for Volumetric Measurement Using Multiple Non-Coplanar Cameras,” each of which are hereby incorporated herein by reference in their entireties.

### TECHNICAL FIELD

The present disclosure relates to embodiments of devices, systems, and methods for volumetric measurement technologies, specifically to systems utilizing multiple non-coplanar cameras for accurately determining the fill level of containers such as feed bins. In particular, certain such embodiments disclosed herein relate to the layout, circuitry, cleaning, and location of multiple non-coplanar image sensors.

### BACKGROUND

In the field of volumetric measurement, accurately determining the fill level of containers such as feed bins presents significant challenges. Traditional methods, including load cells and single-point measurement devices, often prove to be costly or limited in their ability to cover a wide area. Load cells, while precise, are expensive and require complex installation. Single-point or narrow-focused devices, such as Light Detection and Ranging (LiDAR) and indirect Time of Flight (iDOF) measurement sensors, suffer from restricted field of view and distance limitations, which can lead to inaccurate measurements. Additionally, these sensors are prone to multi-path interference due to wave reflections, further complicating the measurement process.

Efforts to expand the coverage using concave lenses have resulted in distorted images, rendering depth measurements inaccurate. Current camera-based solutions require users to input specific geometrical features of the containers into the system before the system takes any readings, adding complexity and potential for error. Moreover, maintaining device cleanliness in dusty environments is a persistent issue, as traditional cleaning methods are often inadequate for non-coplanar sensor arrays.

### SUMMARY

The present disclosure provides a method and apparatus for accurately estimating the volume size of a bin using a sensor system comprising multiple direct Time of Flight (dTOF) sensors. These sensors are strategically arranged in non-coplanar positions to achieve an expanded field of view through FOV Multiplexing. This configuration allows for the capture of comprehensive depth data from the interior of the bin, with the fields of view of the dTOF sensors slightly overlapping at the edges to create a complete image representing the bin's interior volume.

The captured depth data is processed to estimate the volume size of the bin. This processing involves digitally stitching the data from the multiple sensors to form a concatenated image, followed by calculating the volume based on this image. The system is designed to output the estimated volume size based on the processed depth data.
In Example 1, an apparatus for determining a fill level of a container comprises a housing; a plurality of direct time-of-flight (dTOF) imaging modules mounted to the housing in mutually non-coplanar orientations such that fields of view of adjacent modules partially overlap to provide coverage of an interior of the container; an array of windows disposed in the housing, each window aligned to a respective one of the dTOF imaging modules such that a surface of the window is collinear with an optical axis of the respective module; a cleaning assembly configured to remove dust and debris from each of the array of windows; and an electronics assembly including a processor and memory, the processor being configured to acquire range data from the plurality of dTOF imaging modules, stitch the range data into a concatenated depth representation of at least a portion of the container interior, and determine a fill level based on the concatenated depth representation.
Example 2 relates to the apparatus of Example 1, wherein the housing comprises a plurality of downwardly projecting protrusions each defining a distinct sensor plane for a respective dTOF imaging module.
Example 3 relates to the apparatus of Example 1, wherein at least one of the dTOF imaging modules comprises a single-photon avalanche diode (SPAD) detector and a solid-state emitter.
Example 4 relates to the apparatus of Example 1, further comprising an inertial measurement unit (IMU) operably coupled to the processor, wherein the processor is configured to use an orientation derived from the IMU to compensate for roof angle or sensor pose during volume or fill-level determination.
Example 5 relates to the apparatus of Example 1, wherein the processor is configured to perform self-calibration by detecting a structural feature of the container and estimating at least one of: (i) a container centerline offset of the apparatus, (ii) a reference cross-section of the container, and (iii) an empty interior volume of the container.
Example 6 relates to the apparatus of Example 1, wherein the overlap between fields of view of adjacent modules is selected to tolerate manufacturing and assembly variation while preserving contiguous interior coverage.
Example 7 relates to the apparatus of Example 1, wherein each window comprises an antistatic coating configured to reduce dust accumulation.
Example 8 relates to the apparatus of Example 1, wherein a collinearity tolerance between the surface normal of each window and the optical axis of the respective imaging module is ±2 degrees or tighter.
Example 9 relates to the apparatus of Example 1, wherein the cleaning assembly comprises a servo-driven bristled brush arranged to traverse all windows along a cleaning path defined by the housing.
Example 10 relates to the apparatus of Example 1, wherein the electronics assembly stores a machine-learned classifier and is configured to identify a material type within the container from sensor data and associate a density with the material type to compute weight from a determined volume.
Example 11 relates to the apparatus of Example 1, wherein the container is selected from a feed bin, a liquid tank, or a shipping container.
In Example 12, a monitoring system for an interior of a container comprises a housing; a plurality of direct time-of-flight (dTOF) imaging modules mounted to the housing in mutually non-coplanar orientations configured such that fields of view of adjacent modules partially overlap to provide coverage of the interior of the container; an electronics assembly including a processor and memory configured to acquire range data, stitch the range data into a concatenated depth representation, and determine a fill level; an external power-and-communications module comprising a solar panel, a rechargeable battery electrically coupled to the solar panel, a microcontroller (MCU), and a long-range low-power radio transceiver with an antenna; and a mounting bracket configured to suspend the housing, the mounting bracket including a hook to engage a rim or collar of the container.
Example 13 relates to the monitoring system according to Example 12, wherein the long-range low-power radio transceiver comprises a LoRa transceiver, the MCU being configured to telemeter volume or fill-level data to a remote service.
Example 14 relates to the monitoring system according to Example 12, wherein the mounting bracket further comprises an offset portion configured such that a center of mass of the mounting bracket with the housing mounted thereto is beneath the hook in use.
Example 15 relates to the monitoring system according to Example 12, further comprising an array of windows disposed in the housing, each window aligned to a respective one of the dTOF imaging modules such that a surface of the window is collinear with an optical axis of the respective module.
Example 16 relates to the monitoring system according to Example 12, wherein the mounting bracket includes integrated cable routing features that guide an electrical cable between the housing and the external power-and-communications module.
In Example 17, an optical sensor head for interior volume sensing comprises a generally circular housing having a plurality of bottom-facing protrusions each defining a respective sensor plane; a plurality of direct time-of-flight (dTOF) imaging modules arranged symmetrically about a central axis of the housing, each mounted in a non-coplanar orientation; an array of coverglasses each seated at a respective protrusion and aligned so that a surface normal of each coverglass is collinear with an optical axis of a corresponding imaging module; a cleaning mechanism including at least one wiper or brush that is movable across all coverglasses; and per-module signal processing circuitry configured to output depth frames.
Example 18 relates to the optical sensor head according to Example 17, wherein the plurality of imaging modules comprises four imaging modules, and wherein the non-coplanar orientations are selected from one of the following: (i) tilt of −21° in an x/z plane and +19.5° in a y/z plane (±1°), and (ii) rotation about z by 45° followed by a −28° rotation about a vertical line through a corner of each of the imaging modules (±1°).
Example 19 relates to the optical sensor head according to Example 17, wherein the signal processing circuitry comprises a custom system-on-chip (SoC) integrating at least a laser driver, power management, and time-of-flight signal processing.
Example 20 relates to the optical sensor head according to Example 17, further comprising at least one light-intensity sensor configured to be oriented toward a container interior and a controller configured to generate a lid-open alert when measured intensity exceeds a threshold indicative of direct ambient light. This technology is adaptable for use in various regular-shaped containers, including feed bins, liquid containers, and shipping containers. It is particularly suited for measuring the volume of feed within a feed bin. Additionally, the sensor system can be powered by an external solar-powered battery module, providing a sustainable energy source for the apparatus.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

The following drawings are illustrative of particular examples of the present invention and therefore do not limit the scope of invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is a view of the exterior of an example container according to an embodiment of the present disclosure.

FIG. 2 is a schematic cross section of a sensor system according to an embodiment of the present disclosure.

FIG. 3A is an isometric view of the bottom of a sensor module according to an embodiment of the present disclosure.

FIG. 3B is an isometric view of the bottom of a sensor module with the bottom cover removed according to an embodiment of the present disclosure.

FIG. 4A is a bottom view of a sensor module showing the protrusions and windows according to an embodiment of the present disclosure.

FIG. 4B is a bottom view of the sensors within the protrusions of a sensor module according to an embodiment of the present disclosure.

FIG. 4C is a close-up schematic of a sensor according to an embodiment of the present disclosure.

FIG. 5A is a bottom view of a sensor module showing the wipers on the protrusions of the module according to an embodiment of the present disclosure.

FIG. 5B is a close-up view of the wipers on the protrusions of a sensor module according to an embodiment of the present disclosure.

FIG. 6A is an isometric view of a bracket according to an embodiment of the present disclosure.

FIG. 6B is an isometric view of the hook of a bracket according to an embodiment of the present disclosure.

FIG. 7 is a cross-sectional schematic of the location of the sensor module within a feed bin according to an embodiment of the present disclosure.

FIG. 8A is a schematic of the individual image coverage from the sensors according to an embodiment of the present disclosure.

FIG. 8B is another schematic of the individual image coverage from the sensors according to an embodiment of the present disclosure.

FIG. 8C is a side-view schematic of the individual image coverage from the sensors according to an embodiment of the present disclosure.

### DETAILED DESCRIPTION

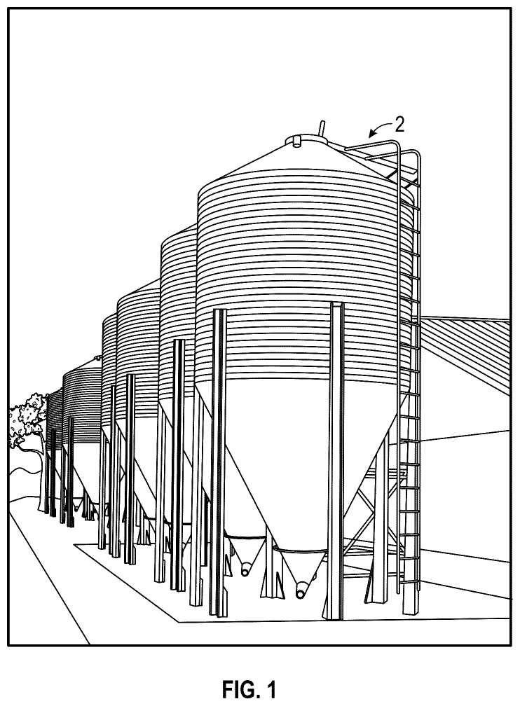

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Accurately measuring the volume of a bin, particularly feed bins, presents a significant challenge in various industries. Traditional methods, such as using load cells, are often prohibitively expensive and require complex installations. Other approaches, like single-point or narrow-focused LiDAR sensors, suffer from limited fields of view (FOV), which restrict their ability to capture comprehensive data about the bin's interior. Indirect Time of Flight (iTOF) sensors, while offering a wider range, also face limitations in FOV and distance. Additionally, iTOF sensors are prone to multi-path interference due to “bouncing” waves, which can lead to inaccurate measurements.

Current solutions for measuring bin volume have several disadvantages. Load cells, while precise, are costly and require significant infrastructure changes for installation. Single-point LiDAR sensors provide limited data due to their narrow FOV, making them unsuitable for capturing the full volume of larger bins. Wider range iTOF sensors, although offering a broader FOV, still fall short in terms of distance and are susceptible to multi-path interference, which can distort measurements. These limitations necessitate a more effective and economical solution for accurately determining bin volume.

Embodiments of the present disclosure address these challenges by employing a sensor system that utilizes multiple direct Time of Flight (dTOF) sensors arranged in non-coplanar positions. This configuration expands the field of view through FOV Multiplexing, allowing for a comprehensive capture of the bin's interior. The dTOF sensors are mounted in a symmetric arrangement to maximize coverage and ensure optimal interior visibility. By digitally stitching the data from multiple sensors, the system creates a concatenated image that accurately represents the bin's volume. This method not only improves measurement accuracy but also reduces costs by utilizing common, low-cost dTOF sensors and custom System on Chip (SoC) circuitry. In certain of these systems, the sensor system is designed to self-calibrate, eliminating the need for user input of the bin's geometrical features, further enhancing the system's practicality and ease of use.

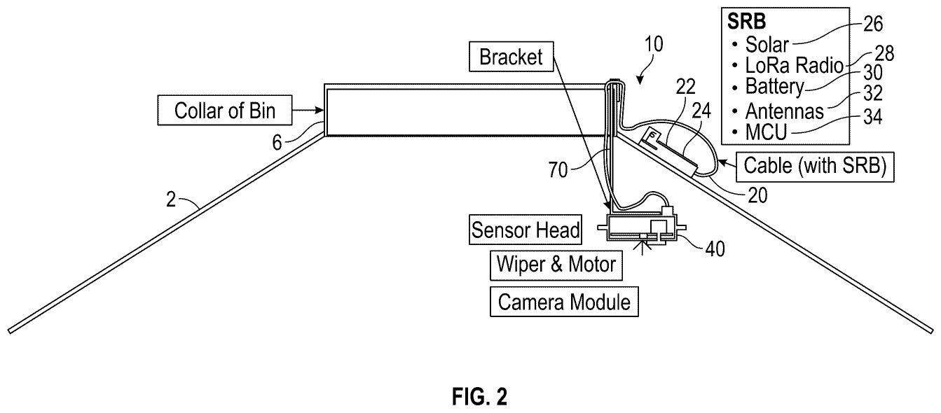

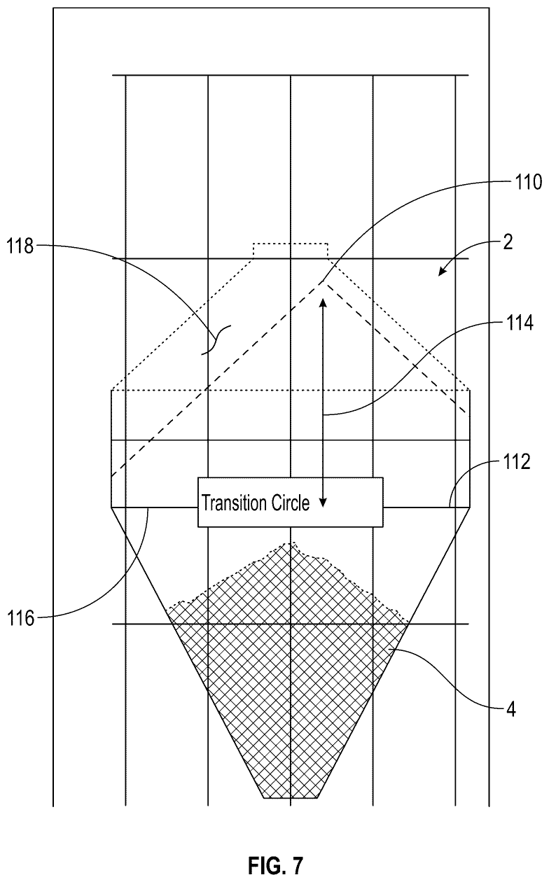

In general, looking at FIGS. 1 and 2, in some embodiments, the system 10 is located onto a container 2 (e.g., a feed bin is shown in the figures, but it should be known that the container 2 may be any other type of opaque container whereby the volume of the internal contents need to be known and may be difficult to see from the outside and/or within which it may be difficult to gain entrance). The system 10 may include an external solar-powered battery module 20, a bracket 70, and a sensor module 40. The solar-powered battery module 20 may be disposed on the outside of the feed bin 2 such that an on-board solar panel has line of sight to sunlight to generate the electrical power to run the system 10. The sensor module 40 may be disposed within the feed bin 2 such that the on-board imaging sensors have access to the interior of the feed bin 2 to detect the exterior wall of the bin 2 and/or the level of the contents 4 (as shown in FIG. 7) of the feed bin 2. The sensor module 40 may be located using the bracket 70 coupled to the collar 6 and extending into the interior of the feed bin 2. The sensor module 40 may be electrically coupled to the external solar-powered battery module 20 for both electrical power and sensor information communication through cables routed through the bracket 70 and to each of the battery module 20 and the sensor module 40.

### External Solar-Powered Battery Module

In some embodiments, the sensor system 10 is powered by an external solar-powered battery module (or Solar Radio Box, SRB) 20 electrically coupled to the sensor system. This configuration provides a sustainable and autonomous power source, reducing the dependency on traditional electrical grids or frequent battery replacements. By utilizing solar energy, the system can operate in remote or off-grid locations where conventional power sources are unavailable or unreliable. This arrangement enhances the system's versatility and applicability in various environments, such as agricultural fields or isolated storage facilities. The integration of a solar-powered battery module ensures continuous operation, even in areas with limited infrastructure, thereby maintaining the accuracy and reliability of volumetric measurements without interruption. Additionally, this setup contributes to reducing the overall operational costs and environmental impact by leveraging renewable energy sources.

The external solar-powered battery module 20 may be any size, shape, and configuration and is configured to generate and store power and/or receive and transmit sensor information related to the volume of the contents 4 of the interior of the feed bin 2 wirelessly. Looking at FIG. 2, in some embodiments, the battery module 20 is placed on the top of the feed bin 2 and facing a direction that maximizes the amount of sunlight available to a solar panel disposed on a top portion of the battery module. As shown in FIG. 2, in some embodiments, the battery module 20 includes a battery module body 22, a solar panel 24, a long-range, low power (LoRa) radio 26, one or more batteries 28, one or more antennas 30, an inertial measurement unit (IMU) 34, and/or a microcontroller unit (MCU) 32.

In some embodiments, the battery module body 22 may be any size, shape, and configuration to provide easy placement of the battery module, provide the attached solar panel with access to sunlight, provide the antenna or antennas with a stable platform, and protect the battery and other internal electronics. As shown in the figures, the battery module body 22 is a substantially rectangular prism shape, although it should be known that the battery module body 22 may be any shape to accomplish the above cited ends. The battery module body may be constructed of any suitable material such as plastic, metal, or any other material.

In some embodiments, the solar panel 24 is disposed on a top portion of the battery module body and may be any size, shape, and configuration and is configured to absorb sunlight and convert the absorbed sunlight into electrical power. The solar panel may be any solar panel known in the art and of any size suitable to generate enough electricity to power the battery for its intended use.

In some embodiments, the LoRa radio 26 may be any size, shape, and configuration suitable to wirelessly communicate sensed data received from the sensor module to the surrounding area. The LoRa radio may be any LoRa radio known in the art suitable to communicate the data relating to the volume of contents 4 within the feed bin to the surrounding area.

In some embodiments, the battery 28 may be any size, shape, and configuration suitable to store electrical power from the solar panel and distribute the stored electrical power to the LoRa radio, the antenna or antennas, the MCU, and/or the sensor module. The battery may be any battery known in the art suitable for receiving and storing electrical power from a solar panel and correctly distributing the power to the respective elements.

In some embodiments, the antenna 30 may be any size, shape, and configuration suitable to transmit and receive signals to and from the LoRa radio 26 to the surrounding area. The antenna 30 may be any antenna known in the art suitable for transmitting electrical signals and receiving electrical signals to enough of a surrounding area such that a user may easily communicate with the system through the LoRa radio 26 via the antenna 30.

In some embodiments, the MCU 32 may be any size, shape, and configuration suitable to control the various functions of the battery module. The MCU may be any MCU known in the art suitable for coupling to and controlling the electrical energy stored in the battery from the solar panel, controlling the signals received by and transmitted from the LoRa radio via the antenna, and controlling the energy distributed by the battery to the various electrical elements of the system.

In some embodiments, the IMU 34 may be any size, shape, and configuration suitable to accurately measure the slope of the roof of the container 2. The IMU may be any IMU known in the art suitable for securely residing within the battery module 20 and sensing an angle at which the battery module is disposed. From this angle, it can be inferred that the slope of the roof of the container 2 is at the same or very similar angle. The IMU in certain embodiments senses this angle using one or more accelerometers, gyroscopes, and/or magnetometers.

### Sensor Module

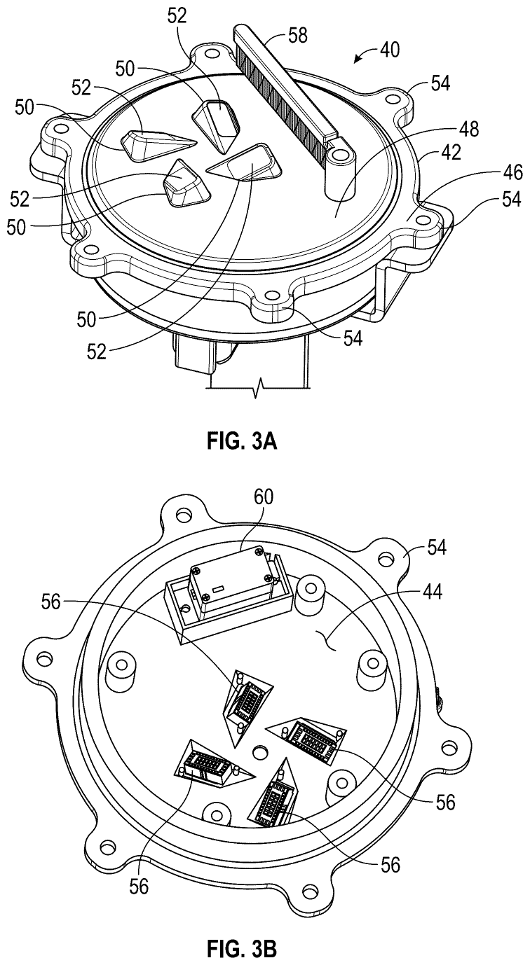

In some embodiments such as shown in FIGS. 3A and 3B, the sensor module 40 may be any size, shape, and configuration suitable to provide a stable platform for a number of imaging sensors 56 to be placed at advantageous vantage points, and to provide a means for keeping the surface of the imaging sensors 56 clean and functioning correctly. As shown, the sensor module 40 may include a sensor module housing 42, a number of imaging sensors 56, and optionally a wiper or multiple wipers 58, and a servo motor or motors 60 for running the wiper or wipers 58.

In some embodiments, the sensor module housing 42 may be any size, shape, and configuration suitable to for containing and protecting the imaging sensors 56 and any optional servo motors 60 and providing a stable platform for the imaging sensors 56 to receive data related to the volume of the contents 4 within the feed bin 2 and/or the corresponding wiper or wipers 58. As shown, the sensor module housing 42 is generally circular in shape (although it should be known that the sensor module housing may take any shape suitable for its intended purpose) and has an interior 44 and exterior 42. The sensor module housing 42 may in some embodiments include a number of attachment bosses 54 around a perimeter of the sensor module housing 42 for securely connecting to the bracket 70.

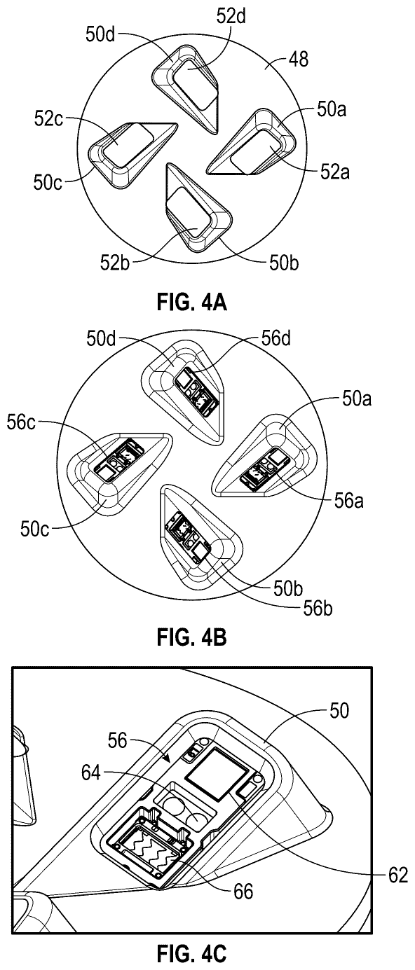

As shown in FIG. 4, on a bottom side of the exterior 46 of the sensor module housing 42, in some embodiments, a number of protrusions 50 extend generally downwardly from a bottom surface 48 of the exterior 46 of the sensor module housing 42. The protrusions 50 each may be any size, shape, and configuration suitable to aim one of the imaging sensors 56 at a predetermined angle configured to capture at least a partial image of the interior of the feed bin 2. As shown in FIG. 4, the protrusions 50 have a general shape of a frustum of a pyramid, each having the top portion of the pyramid cut on a predetermined sensor plane 52.

In the embodiment shown in FIG. 4A, there are four protrusions 50 each having a sensor plane 52a-d, although it should be known to one of ordinary skill in the art that there may be two, three, five, six, eight, or any other number of protrusions and associated imaging sensors within the sensor module 40. As will be described in more detail below, in some embodiments the sensor planes 52a-d are predetermined to maximize the sensed area from the image sensors 56a-d (as shown in FIG. 3B) while simultaneously minimizing (but not necessarily eliminating) the overlap between the images of the sensors 56a-d.

In some embodiments, the sensor planes are configured 52a-d in a symmetric arrangement to enhance the field of view and ensure effective coverage of the bin's interior. This symmetric arrangement allows for a more uniform distribution of the sensors' fields of view, which is particularly beneficial in capturing comprehensive depth data from the bin's interior. By ensuring that the sensors are symmetrically positioned, the method reduces the likelihood of blind spots and enhances the accuracy of the volume estimation. This configuration is advantageous for rotationally symmetric structures like feed bins, as it aligns with their geometric properties, thereby improving the reliability of the measurements. Additionally, the symmetric arrangement facilitates easier calibration and maintenance, as the uniformity in sensor placement simplifies the alignment and cleaning processes. This approach addresses the limitations of asymmetric sensor arrangements, which can lead to uneven coverage and potential inaccuracies in volume measurement. In the embodiment shown in FIG. 4A, the sensor planes 52 are angled 90° from one another, and tilted −21° in the x/z plane and 19.5° in the y/z plane, +/−1°. In still other embodiments, the sensor planes are rotated about the z axis by 45° then rotated −28° about a vertical line (parallel to the axis) that also passes through the lower right corner of the optical module, +/−1°.

In some embodiments, the image sensors 56 may be any size, shape, and configuration suitable to gather image data related to the distance of the contents 4 of the feed bin 2 from the sensors 56 over some area. As shown in FIGS. 4B-4C, the image sensors may be any image sensors known in the art such as a high field of view (FOV) single photon avalanche diode (SPAD) based direct time of flight (dTOF) implementation. In such embodiments such as detailed in FIG. 4C, the sensors may include an emitter 62, a camera component 64, and power conditioning elements 66.

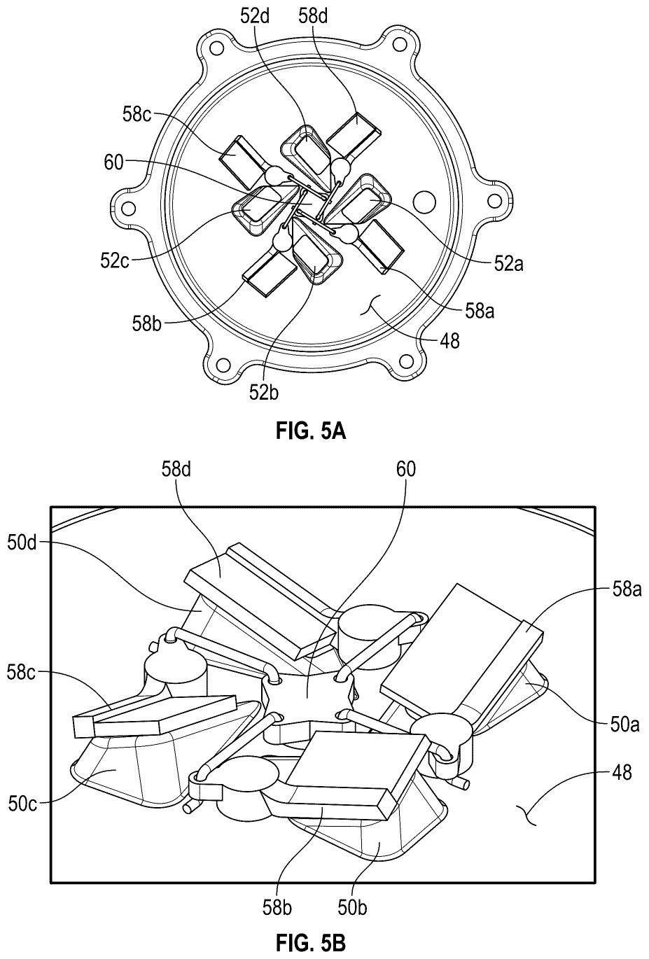

In some embodiments such as shown in FIGS. 5A-5B, the wiper or wipers 58 may be any size, shape, and configuration suitable to wipe the exposed surface of the sensors 56 free of dust and other debris from the interior of the feed bin 2. The wiper 58 may be driven by a servo motor 60 in electrical connection with the MCU 32 of the battery module 20 which provides power and electrical signals to run the servo motor 60 which operates the wiper 58. The wiper 58 may be any wiper known in the art such as a rubber (such as shown in FIGS. 5A and 5B), a brush wiper (such as shown in FIG. 3A), or any other type of wiper known in the art. The wiper may be a single wiper 58 for all sensors 56 or may be individualized wipers 58a-d for each sensor 56a-d. In some embodiments, each of the wipers 58a-d have an associated servo motor 60a-d attached.

In some embodiments, the inclusion of a cleaning mechanism comprising a bristled brush mounted to a servo motor ensures that the sensor windows remain free from dust and debris, which is important for maintaining the accuracy and reliability of the depth data captured by the dTOF sensors. The physical arrangement of the bristled brush 58 allows the brush to sweep across the sensor windows 52, effectively removing any obstructions that could interfere with the sensors' ability to capture clear and precise depth measurements. This cleaning mechanism is particularly advantageous in environments where dust accumulation is prevalent, such as in feed bins, where maintaining sensor clarity is important for accurate volumetric measurement. By automating the cleaning process, the system reduces the need for manual maintenance, thereby enhancing the operational efficiency and longevity of the sensor system. This approach addresses the challenge of keeping non-coplanar sensor arrays clean, which traditional cleaning methods may not adequately handle, ensuring consistent performance and reducing the risk of measurement errors due to dirty sensor windows.

### Bracket

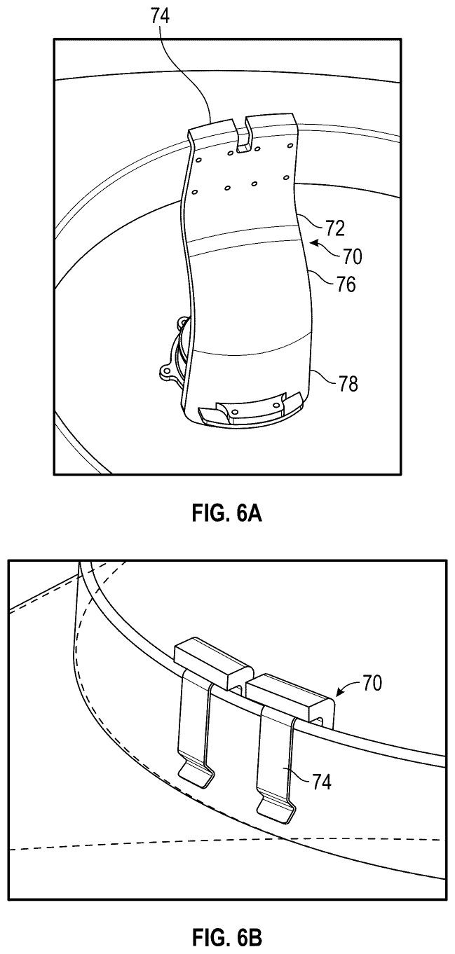

In some embodiments such as shown in FIGS. 6A-6B, the sensor module 40 is securely located using a bracket 70. The bracket 70 may be any size, shape, and configuration to locate and provide a stable platform for the sensor module 40 on the feed bin 2. As shown in FIG. 6A, the bracket in some embodiments includes a base portion 72, a hook 74, an offset portion 76, and a sensor module attachment 78. Looking closer at FIG. 6B, the hook 74 may easily securely and removably attach the proximal end of the bracket 70 to the collar 6 of the feed bin 2.

In some embodiments, the base 72 of the bracket 70 may include an offset portion 76. In some embodiments, a sensor module attachment is disposed on the distal end of the bracket 70 for securely attaching the sensor module 40 to the bracket 70 in any way known in the art (e.g., snap fit, tongue and groove, by fasteners, or any other method known in the art). Although not shown, the bracket 70 may also include cable routing aids to protect and keep secure the cables that connect the sensor module 40 and the battery module 20. In such embodiments, the offset portion 76 is sized and shaped such that the center of mass of the assembled bracket with the sensor module is substantially beneath the hook 74 of the bracket. Substantially beneath the hook in such embodiments means that the bracket 70 does not lean when assembled such that the sensors are able to generate images of the entirety of the interior of the feed bin 2.

### Installation

In some embodiments, the sensor module 40 is coupled to the distal end of the bracket 70 at the sensor module attachment 78. The bracket is then coupled to the top of the feed bin 2 by placing the hook over the collar 6 of the feed bin 2, with the connecting cabled hanging outside of the feed bin 2. The battery module 20 is then securely attached to the outside of the top portion of the feed bin 2 such that the solar panel 24 has line of sight to a maximum of ambient sunlight. The connecting cable from the sensor module is then connected to the battery module and optionally the system is turned on. It should be known that one or more of the installation steps may be performed in a different order (i.e., the battery module may be attached to the top of the feed bin first and connected to the sensor module before coupling the bracket to the collar 6 of the feed bin 2).

### Method of Use

In some embodiments, after the system is installed as described above, the system 10 may self-calibrate. As shown in FIG. 7, the system 10 will self-calibrate or initialize by using the sensors 56 to detect the transition circle 112 of the feed bin. Once the transition circle is detected, the system will compute a distance (height) 114 to and the circumference 116 of the transition circle 112. Using these dimensions, the system will then compute (i) how far off-center the sensor module 40 is located and by extension (ii) the empty volume of the feed bin. This self-calibration capability allows the system to autonomously determine the necessary parameters for accurate volume estimation, reducing the potential for human error and simplifying the setup process. By directly measuring the bin's dimensions, the system can adapt to various bin sizes and shapes without requiring manual input, enhancing the system's versatility and ease of use. This feature is particularly beneficial in environments where bins may vary in size or where manual input is impractical, ensuring consistent and reliable volume measurements across different applications.

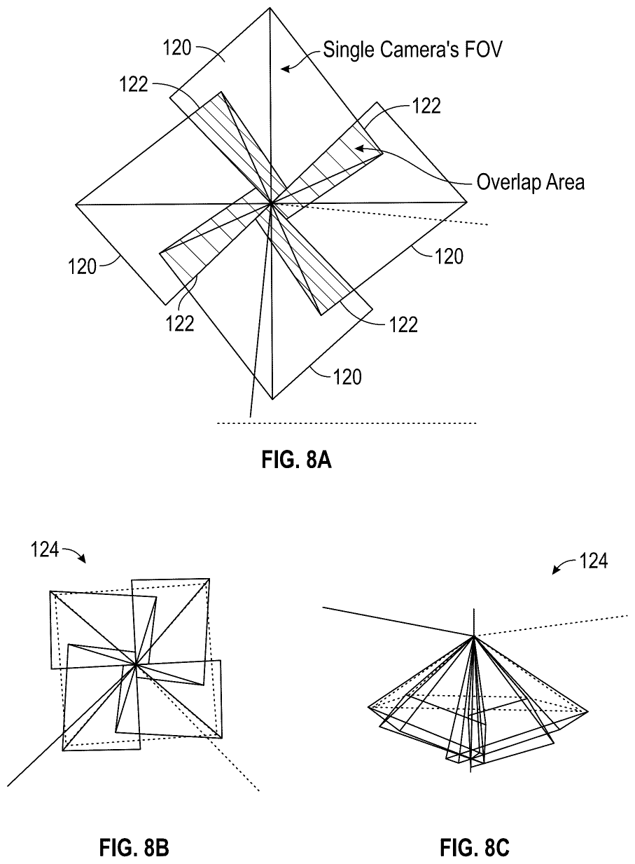

The method for estimating the volume size of the bin 2 using a sensor system 10 with multiple direct Time of Flight (dTOF) sensors 56 arranged in non-coplanar positions 52 is described below. This arrangement allows for an expanded field of view through FOV Multiplexing, which is important for capturing comprehensive depth data from the bin's interior. Looking at FIG. 8A, by overlapping the fields of view 120 of the dTOF sensors 56 slightly at the edges (see overlaps 122 in FIG. 8A), the system creates a complete image 124 such as the top view shown in FIG. 8B and the side view as shown in FIG. 8C that accurately represents a three-dimensional view of the interior volume of the bin 2. This configuration addresses the limitations of single-point or narrow-focused sensors, which often suffer from restricted coverage and distance limitations.

In some embodiments, the method involves processing the captured depth data by digitally stitching the data to form a concatenated image 124, which in some embodiments is then used along with roof angle data from IMU 34 to calculate the bin's total volume. This digital stitching process ensures that the data from multiple sensors 56 is seamlessly integrated, providing a more accurate and reliable volume estimation. The capability to output the estimated volume size based on the processed depth data and the roof angle data offers a practical solution for industries that require precise volumetric measurements, such as agriculture and logistics. With the self-calibration completed, the measurements can then be re-run to sense the height of the contents 4 within the bin 2 and a volume of the contents 4 computed from the updated measurements.

In some embodiments, the sensors 56 may be trained using machine learning techniques to distinguish between types of material of the content 4 within the bin 2. In certain of these embodiments, it may be determined whether the animal feed is a ground corn mixture, a pelleted mixture, or some other mixture. From this sensed type of content 4 within the bin 2, a density may be calculated by the system. Using the volume as sensed above and adding in the density of the type of content 4 within the bin 2, the weight of the content 4 may be calculated with great accuracy.

Some embodiments involve processing captured depth data to compensate for manufacturing tolerances by ensuring adequate overlap regions 122 of the fields of view 120 of the direct Time of Flight (dTOF) sensors 56. This approach addresses potential inaccuracies that may arise from variations in sensor placement or alignment during manufacturing. By designing the system to have FOVs 120 with some overlaps 122, the method ensures that any discrepancies in sensor positioning do not result in gaps in the captured data, thereby maintaining the integrity of the volumetric measurement. This redundancy in coverage allows for a more robust and reliable estimation of the bin's volume, as it mitigates the effects of minor misalignments or deviations in sensor orientation. The overlapping FOVs 120 also enhance the system's ability to capture comprehensive depth data, which is essential for accurately stitching the data into a concatenated image. This method provides a practical solution to the challenges posed by manufacturing tolerances, ensuring consistent performance and accuracy across different units of the sensor system.

Furthermore, the use of dTOF sensors 56 eliminates issues related to multi-path interference, which is common in indirect Time of Flight (iTOF) sensors. This enhances the accuracy of the measurements and reduces the potential for errors caused by wave reflections. The method's capability to self-calibrate by directly measuring important dimensions of the bin further simplifies the process, eliminating the need for user input and reducing the likelihood of human error. This self-calibration feature is particularly advantageous in environments where manual input of bin dimensions is impractical or prone to inaccuracies.

In some embodiments, the sensor system 10 utilizes discrete Metalens Rx/Tx (receiving and transmitting) elements. These elements are separated by a middle recess to reduce cross talk between the Rx and Tx elements. Additionally, custom System on Chip (SoC) circuitry to reduce the cost of the sensor system. The use of discrete Metalens elements allows for the replacement of traditional, high-cost optical components with lithography-based components, which are more cost-effective to produce. This change in implementation reduces the overall manufacturing costs while maintaining the required optical performance for accurate depth measurement. The custom SoC circuitry integrates multiple functionalities, such as power management, laser driver, and signal processing, into a single chip, further reducing the need for separate, expensive components. This integration not only lowers the cost but also minimizes the physical footprint of the sensor system, making the system more compact and easier to install in various applications. By addressing the cost and size constraints, this approach provides a practical and economical solution for volumetric measurement systems, enabling broader adoption across different industries.

In still other embodiments, the sensor system is configured to measure the volume of various regular-shaped containers, including liquid containers and shipping containers. This configuration allows the sensor system to be versatile and adaptable to different container types beyond feed bins. By utilizing multiple direct Time of Flight (dTOF) sensors arranged in non-coplanar positions, the system can capture comprehensive depth data from the interior of these containers, regardless of their specific shape or size. The fields of view of the sensors overlap slightly, ensuring a complete image of the container's interior is captured, which is important for accurate volume calculations. This adaptability is particularly beneficial in industries where containers of different shapes and sizes are used, such as logistics and manufacturing, as this feature allows for consistent and reliable volumetric measurements across various applications. The ability to measure different container types without requiring significant modifications to the sensor system enhances the system's utility and broadens its potential use cases.

In some embodiments, the sensors 56 may be used to determine whether the lid of the bin 2 has been left open inadvertently. In certain embodiments, the sensors 56 may include light intensity sensing capabilities, such that a predetermined amount of light is reflected from the content 4 within the bin 2 to the sensors 56. An intensity that is greater than the predetermined intensity may trigger a notice to the user that the lid may be open, exposing the contents 4 of the bin 2 to moisture and potential spoilage.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. An apparatus for determining a fill level of a container, comprising:
(a) a housing;
(b) a plurality of direct time-of-flight (dTOF) imaging modules mounted to the housing in mutually non-coplanar orientations such that fields of view of adjacent modules partially overlap to provide coverage of an interior of the container;
(c) an array of windows disposed in the housing, each window aligned to a respective one of the dTOF imaging modules such that a surface of the window is collinear with an optical axis of the respective module;
(d) a cleaning assembly configured to remove dust and debris from each of the array of windows; and
(e) an electronics assembly including a processor and memory, the processor configured to:
(i) acquire range data from the plurality of dTOF imaging modules;
(ii) stitch the range data into a concatenated depth representation of at least a portion of the container interior; and
(iii) determine a fill level based on the concatenated depth representation.

2. The apparatus of claim 1, wherein the housing comprises a plurality of downwardly projecting protrusions each defining a distinct sensor plane for a respective dTOF imaging module.

3. The apparatus of claim 1, wherein at least one of the dTOF imaging modules comprises a single-photon avalanche diode (SPAD) detector and a solid-state emitter.

4. The apparatus of claim 1, further comprising an inertial measurement unit (IMU) operably coupled to the processor, wherein the processor is configured to use an orientation derived from the IMU to compensate for roof angle or sensor pose during volume or fill-level determination.

5. The apparatus of claim 1, wherein the processor is configured to perform self-calibration by detecting a structural feature of the container and estimating at least one of: (i) a container centerline offset of the apparatus, (ii) a reference cross-section of the container, and (iii) an empty interior volume of the container.

6. The apparatus of claim 1, wherein the overlap between fields of view of adjacent modules is selected to tolerate manufacturing and assembly variation while preserving contiguous interior coverage.

7. The apparatus of claim 1, wherein each window comprises an antistatic coating configured to reduce dust accumulation.

8. The apparatus of claim 1, wherein a collinearity tolerance between the surface normal of each window and the optical axis of the respective imaging module is ±2 degrees or tighter.

9. The apparatus of claim 1, wherein the cleaning assembly comprises a servo-driven bristled brush arranged to traverse all windows along a cleaning path defined by the housing.

10. The apparatus of claim 1, wherein the electronics assembly stores a machine-learned classifier and is configured to identify a material type within the container from sensor data and associate a density with the material type to compute weight from a determined volume.

11. The apparatus of claim 1, wherein the container is selected from a feed bin, a liquid tank, or a shipping container.

12. A monitoring system for an interior of a container, comprising:
(a) a housing;
(b) a plurality of direct time-of-flight (dTOF) imaging modules mounted to the housing in mutually non-coplanar orientations configured such that fields of view of adjacent modules partially overlap to provide coverage of the interior of the container;
(c) an electronics assembly including a processor and memory, the processor configured to:
(i) acquire range data from the plurality of dTOF imaging modules;
(ii) stitch the range data into a concatenated depth representation of at least a portion of the container interior; and
(iii) determine a fill level based on the concatenated depth representation;
(d) an external power-and-communications module comprising a solar panel, a rechargeable battery electrically coupled to the solar panel, a microcontroller (MCU), and a long-range low-power radio transceiver with an antenna; and
(e) a mounting bracket configured to suspend the housing, the mounting bracket including a hook to engage a rim or collar of the container.

13. The system of claim 12, wherein the long-range low-power radio transceiver comprises a LoRa transceiver, the MCU being configured to telemeter volume or fill-level data to a remote service.

14. The system of claim 12, wherein the mounting bracket further comprises an offset portion configured such that a center of mass of the mounting bracket with the housing mounted thereto is beneath the hook in use.

15. The system of claim 12, further comprising an array of windows disposed in the housing, each window aligned to a respective one of the dTOF imaging modules such that a surface of the window is collinear with an optical axis of the respective module.

16. The system of claim 12, wherein the mounting bracket includes integrated cable routing features that guide an electrical cable between the housing and the external power-and-communications module.

17. An optical sensor head for interior volume sensing, comprising:
(a) a generally circular housing having a plurality of bottom-facing protrusions, each protrusion defining a respective sensor plane;
(b) a plurality of direct time-of-flight (dTOF) imaging modules arranged symmetrically about a central axis of the housing, each mounted in a non-coplanar orientation;
(c) an array of coverglasses each seated at a respective protrusion and aligned so that a surface normal of each coverglass is collinear with an optical axis of a corresponding imaging module;
(d) a cleaning mechanism including at least one wiper or brush that is movable across all coverglasses; and
(e) per-module signal processing circuitry configured to output depth frames.

18. The optical sensor head of claim 17, wherein the plurality of imaging modules comprises four imaging modules, and wherein the non-coplanar orientations are selected from one of the following:
(i) tilt of −21° in an x/z plane and +19.5° in a y/z plane (±1°), and
(ii) rotation about z by 45° followed by a −28° rotation about a vertical line through a corner of each of the imaging modules (±1°).

19. The optical sensor head of claim 17, wherein the signal processing circuitry comprises a custom system-on-chip (SoC) integrating at least a laser driver, power management, and time-of-flight signal processing.

20. The optical sensor head of claim 17, further comprising at least one light-intensity sensor configured to be oriented toward a container interior and a controller configured to generate a lid-open alert when measured intensity exceeds a threshold indicative of direct ambient light.
